(19) United States
(12) Patent Application Publication
(10) Pub. No.: US 2024/0091711 A1
(43) Pub. Date: Mar. 21, 2024

(54) Leaf Assembly for Water Treatment and Method of Assembly Thereof

(71) Applicant: Renew Health Ltd, Athlone (IE)

(72) Inventors: William Tally, Milford, MI (US); Dereck Kowalski, Macomb, MI (US); Mitch O'Brien, Royal Oak, MI (US); Orest Yavtushenko, Farmington Hills, MI (US)

(21) Appl. No.: 18/273,568

(22) PCT Filed: Jan. 21, 2022
(86) PCT No.: PCT/US2022/013301

§ 371 Date: Jul. 21, 2023

Related U.S. Application Data
(60) Provisional application No. 63/139,903, filed on Jan. 21, 2021.

(51) Int. Cl. B01D 63/08

(52) U.S. Cl. CPC B01D 63/081; B01D 61/025

(57) ABSTRACT

The disclosure relates to assembled membranes used in water treatment systems, including membranes used in reverse osmosis procedures and methods for making and using the membranes.

### BACKGROUND

There is increasing concern about water quality that is provided to homes, businesses, and public facilities, due, as least partly, to recent failures in the public water supply. There is a push to create improved systems that can accommodate demand for water treatment, and which may be installed at the point of use. In particular, water treatment using reverse osmosis processes has become particularly popular for water purification. Consequently, there is a need to improve water treatment systems that incorporate reverse osmosis components. For example, it would be beneficial to reduce the production and maintenance costs of assembled membranes used in water treatment systems while maintaining or improving performance.

### SUMMARY

The disclosure relates to assembled leaves used in water treatment systems, including reverse osmosis systems. The assembled membranes include at least one layer of glue applied to a membrane such that the at least one glue layer seals a portion of membrane when the membrane is folded over. In some examples, the glue layer may also fix a mesh element or spacer incorporated into the assembled membrane. The disclosure also relates to methods of making the assembled membranes and methods of incorporating the assembled membranes into water treatment systems.

### BRIEF DESCRIPTION OF FIGURES

FIG. 1 shows a cross-sectional view of a membrane as seen from the side according to the disclosure, showing the relationship between components.

FIG. 2 shows a perspective view of a membrane showing the pattern of glue applied to an example of a membrane.

FIG. 3 shows an example of mesh element or spacer according to the disclosure.

FIG. 4 shows one example of a glue application station as seen from above.

FIGS. 5a and b shows a further example of a glue application station according to the disclosure.

FIG. 6 shows the one view of a system for manufacture of leaves for reverse osmosis cassettes according to the disclosure.

FIG. 7 shows a portion of a system for manufacture of leaves according to the disclosure.

FIGS. 8a and 8b shows components of a system for the manufacture of leaves.

FIGS. 9a and 9b show certain features of a system to manufacture leaves.

FIG. 10 shows an example of a partially assembled leave according to the disclosure.

FIG. 11 shows a portion of a system according to the disclosure showing the collection of assembled leaves in the system.

### DETAILED DESCRIPTION

The systems and methods described herein are not limited in their application to the details of construction and the arrangement of components set forth in the description or illustrated in the drawings. The present disclosure is capable of other disclosure and of being practiced or of being carried out in various ways. Also, the phraseology and terminology used herein is for the purpose of description and should not be regarded as limiting. The use of “including”, “comprising”, “having”, “containing”, “involving” and variations thereof herein, is meant to encompass the items listed thereafter, equivalents thereof, and additional items, as well as alternate examples consisting of the items listed thereafter exclusively.

Other aspects, embodiments, and advantages of these exemplary aspects and embodiments are discussed in detail below. This description is intended to provide an overview or framework for understanding the nature and character of the claimed aspects and examples. The accompanying drawings are included to provide illustration and a further understanding of the various aspects and examples and embodiments and are incorporated in and constitute a part of this specification. The drawings, together with the specification, serve to explain the described and claimed aspects and embodiments.

This disclosure relates to water treatment. In preferred examples, the disclosure relates to assembled leaves used in water purification systems. The disclosure also relates to methods and systems for preparing and using the leaves. In particularly preferred examples, the disclosure relates to leaves incorporated into reverse osmosis components and also to methods of assembling the leaves.

According to the disclosure, assembled leaves made using the disclosed methods and systems have fewer faults, resulting in less waste, or reduced costs, or a combination of less waste and reduced costs. Further, assembled membranes produced according to the disclosure have superior properties when used in water treatment systems. For example, the assembled membranes are less likely to form creases. Consequently, for example, a plurality of leaves may be assembled more compactly in a filtration component, such as a reverse osmosis element.

According to the disclosure, the assembled leaves are more stable during production and storage. For example, the incorporated mesh element or spacers found in reverse osmosis components are less likely to shift or move during assembly and storage using the disclosed methods. Consequently, the use of the assembled membranes reduces waste, maintenance costs or both waste and maintenance costs.

In general, the disclosure describes the application of glue to prepare membranes for use in water filtration procedures. In preferred examples, the application, placement or deposition of at least one layer of glue maintains, stabilizes, or fixes in place components of the assembled leaf. For example, the relative positioning of components of a leaf are maintained during use and during storage.

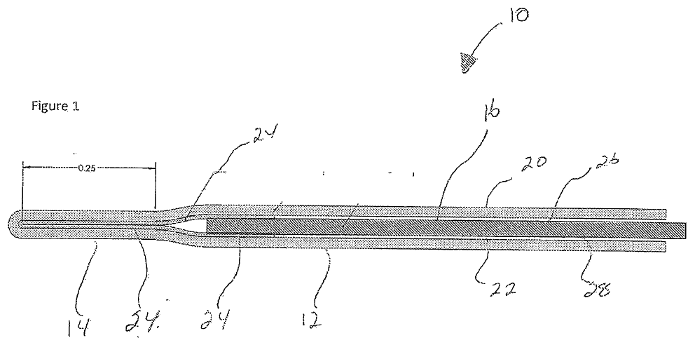

FIG. 1 shows a cross-section of an assembled membrane 10 according to the disclosure. Membrane 12 has first surface 20 and second surface 22. For example, the first and second surfaces may be the external and internal surfaces of a reverse osmosis membrane. In this and further example, the membrane is represented as planar and as a rectangle, but the membrane may assume other shapes, as required for a particular application. In this example, the membrane has a width of about 35 to 45 inches, preferably about 40 to about 41 inches.

In this example, membrane 12 is shown folded over forming a sandwich-like structure with mesh element enclosed between by the membrane. According to the disclosure, the folding process results in fold portion 14 that does not contact mesh element 16. Mesh element 16 is shown having first surface 26 and second surface 28. In the assembled leaf 10, mesh element 16 is enclosed by membrane 12 such that mesh element 16 contacts membrane second surface 22 at both mesh element first surface 26 and mesh element second surface 28. The contact between membrane second surface 22 and mesh element surfaces 26,28, is present along the entire assembled leave, except mesh elements are absent in the fold portion 14.

According to this example, glue is applied to the second surface 22 of membrane 12 such that glue layer 24 is present in the fold portion 14. In this example, the applied glue layer 24 thickness is about 0.5 mil thick. In this example, the fold portion is about 0.25 inches in length.

In this example, glue layer 24 also extends from fold portion 14 to contact an adjacent portion of second surface 22 and also contacts the first and second surfaces 26,28 of mesh element 16. In this example, glue layer 24 extends about 0.5 inches along the first and second surfaces 26,28 of the mesh element 16. The length of the fold portion 14 and the dimensions of glue layer 24 may be adjusted to the requirements of particular situations.

According to the disclosure, a watertight seal is formed at fold portion 14, due to glue layer 24. The presence of the glue layer 24 also ensures that the fold portion 14 remains completely flat, without forming, for example, creases or other imperfections. The presence of the glue layer 24 also reduces movement of the membrane during use or during storage. Consequently, the use of the assembled leaves of the disclosure reduce waste or reduce cost. Further, in this example, glue layer 24 is placed such that it holds mesh element 16 in place, thereby preventing mesh element 16 from moving or shifting during production, use, or storage.

In preferred examples, the at least one glue layer is from about 0.2 mil to about 2 mil in thickness. In particularly preferred examples, the at least glue layer is about 0.5 mil in thickness. The glue layer may be applied in one or more applications of glue to achieve the desired amount. The glue may be selected for compatibility with standards described for water purification systems. In preferred examples, the glue is silicon-based. Processes of the disclosure may be used on existing membrane and mesh element components. For example, the disclosed procedure is compatible with polyamide/polysulfone membranes and with mesh element made of polypropylene.

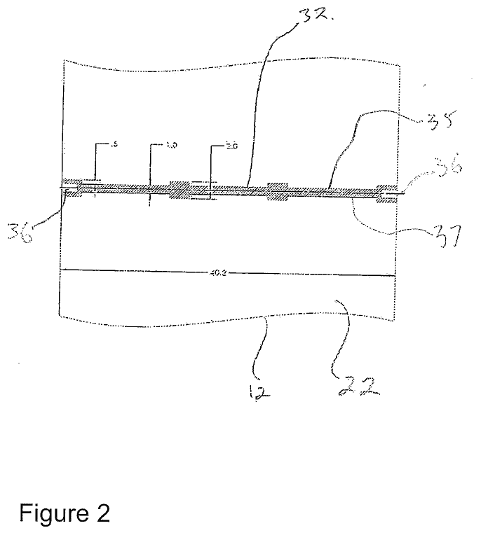

According to the disclosure, at least glue layer may be applied on various patterns as required, for example, FIG. 2 shows different patterns of glue application. In this example, glue layer 32 is shown applied to second surface 22 of membrane 12. In this example, glue was applied in two stripes 35, 37. Further, glue was excluded from regions 36 at the left- and right-hand edges of the membrane. In this example, structures such as gripping pins may be placed at these regions to hold the membrane in place during folding process to form a leaf, as described below.

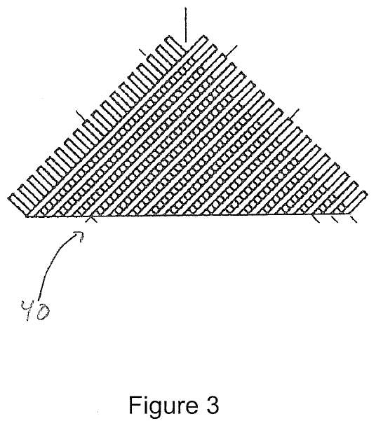

FIG. 3 shows an example of a portion of mesh element 40 or spacer used in reverse osmosis procedures. In preferred examples, the width of the mesh element is the same as the width of them membrane.

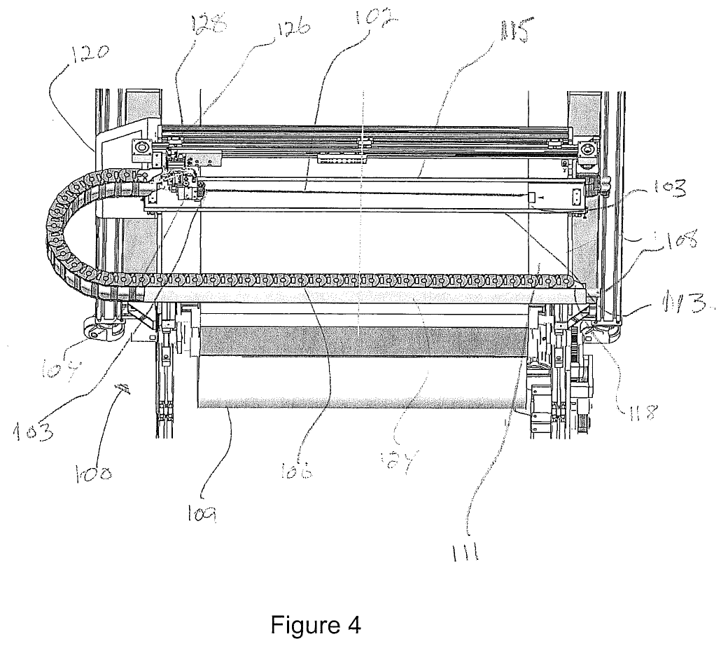

In preferred examples, at least one glue layer is applied at a glue application station. FIG. 4 shows one example of a glue application station. In this example, roll 109 includes membranes, such as membranes used in reverse osmosis procedures. A portion of the membrane is moved, such as spooled, onto table 111 where at least one glue layer may be applied.

In this example, at least one glue layer 102 is placed or laid down in a straight line on the membrane 100 by glue applicator 104, starting from the righthand edge of the membrane 103 to the left-hand edge 105 of the membrane. Carriage 107 is present to hold the membrane in place during the application of glue. In this example, carriage 107 includes two rails 113,115. The rails run parallel to the glue layer and hold the membrane in place immediately above and below the glue layer during glue application. The carriage is raised above the surface of the table to allow movement of membranes onto or off the table 111.

Applicator belt 106 is placed in belt track 124 and is also fixed to support arm 108 at one end of the Applicator belt. A second end of the belt 106 is fixed to mount 126. Motor 130 moves glue applicator 104 along rail 128. Applicator belt 106 is retracted with movement of the glue applicator 104 to stabilize glue applicator 104 and ensure precise deposition of glue layer 102. In this example, the glue layer 102 is deposited by the glue applicator in from about one second to about 5 seconds. In this example, glue is heated from about 325° F. to about 375° F., preferably about 350° F. Controller 120 controls the parameters of glue application, such as deposition pattern.

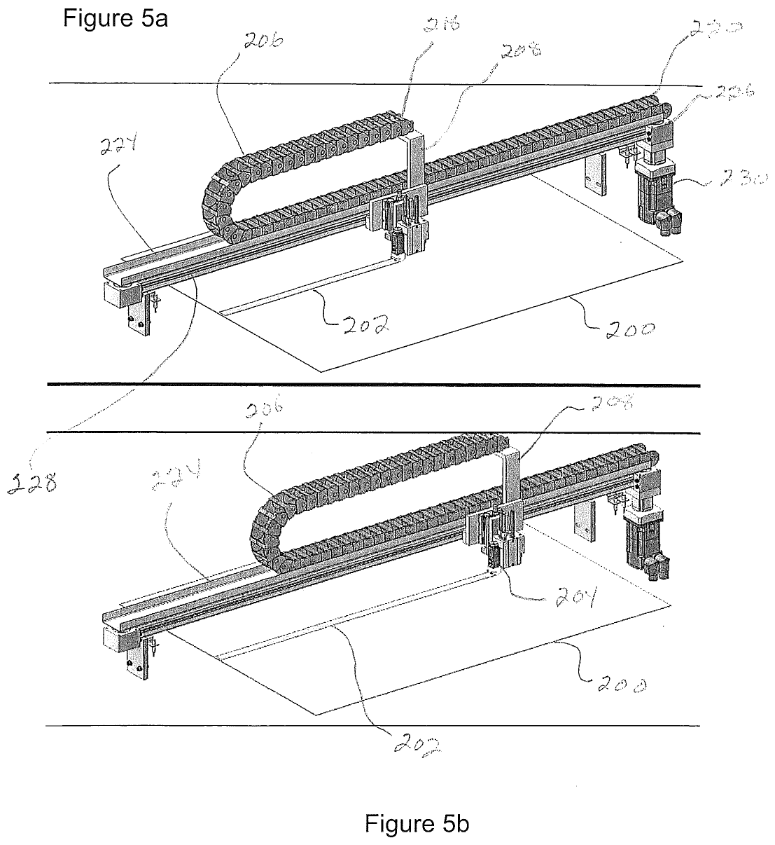

FIGS. 5a and 5b show a further example of a glue application station. In this example, glue layer 202 is shown placed on membrane surface 200 where the applicator is positioned at two different points on the membrane in FIGS. 5a and 5b. Glue applicator 204 is mounted on applicator support arm 208. Glue applicator 104 also engages with rail 228. Applicator belt 206 is placed in belt track 224 and is also fixed to support arm 208 at one end 218 of the belt. A second end of the belt 220 is fixed to mount 226. Motor 230 moves glue applicator 204 along rail 228. Applicator belt 206 is retracted with movement of the glue applicator 204 to stabilize glue applicator 204 and ensure precise deposit of glue layer 202.

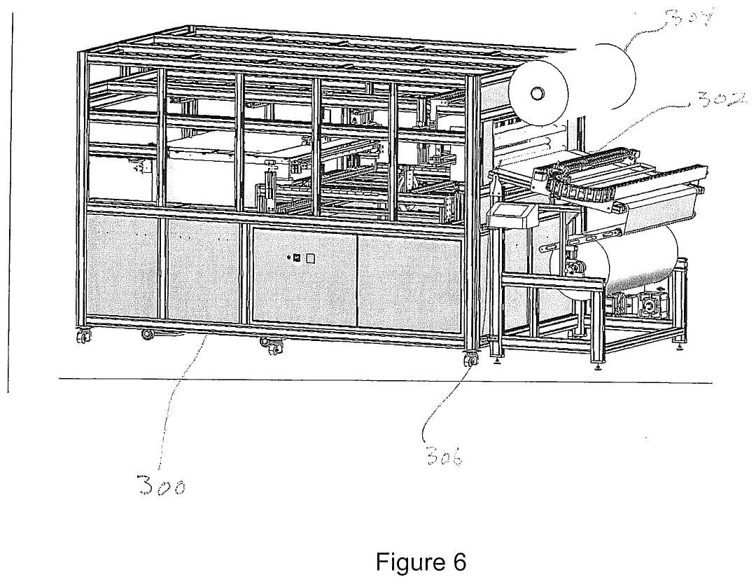

One or more glue application station may be made part of a system for assembling leaves. For example, as shown in FIG. 6, the glue application station 302 of FIG. 4 is shown as part of a system 300 for assembling leaves. In this example, the mesh element 304 is shown in a roll where the mesh element is moved using rollers 306.

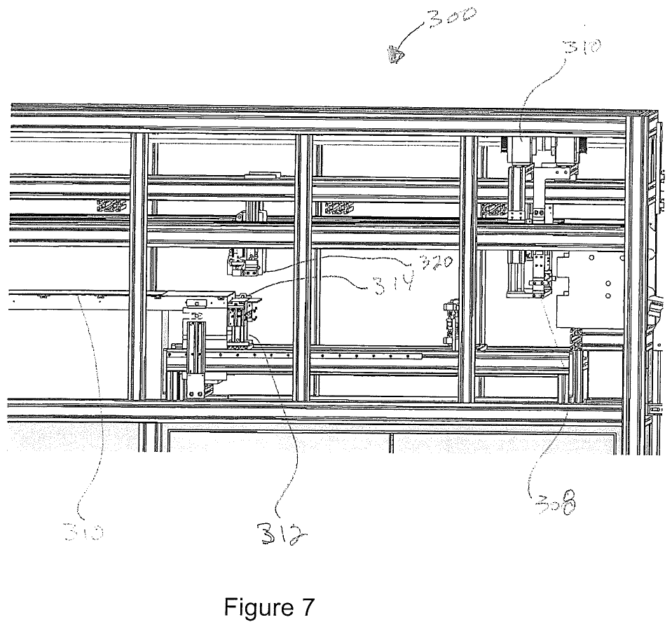

FIG. 7 shows a further view of the system of FIG. 6 showing the movement of the mesh element and membranes to a folding station where membrane and mesh element are assembled into a leaf. In this example, the membrane with at least one glue layer and mesh element 304 is pulled into the system using a set of grippers 308 to for each of the membrane and mesh. Pull servos 310 pull the membrane and mesh element into the system along a belted track to material bed 310.

According to this example, material bed 310 floats the material and keeps the sheets flat during folding. The membrane is pulled twice as long as the mesh, so that when it is crimped, the balance of the membrane can be pulled back over top to create a sandwich effect with the mesh, resulting in an an assembled leave.

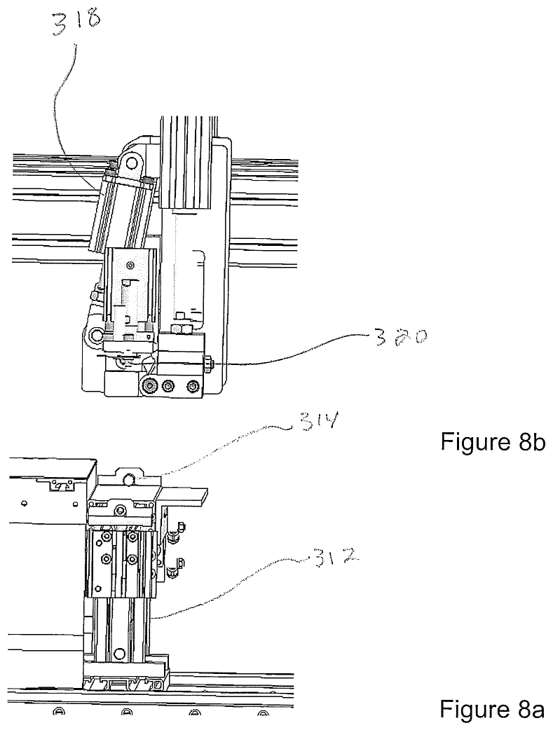

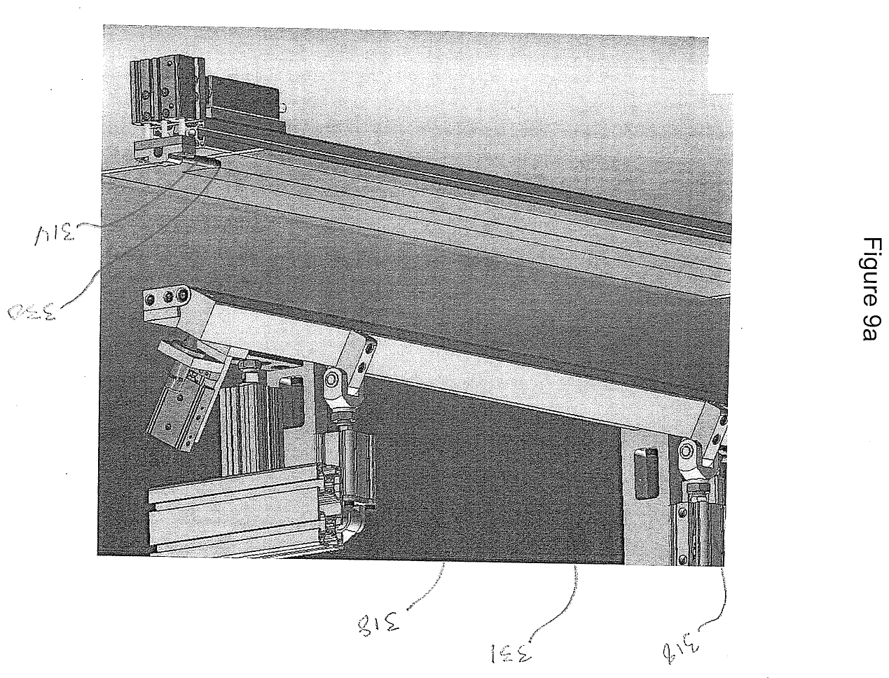

FIGS. 7 and 8a, b show details of the folding of the membrane and mesh. According to this example, a gripper pin cylinder 312 is raised into position the accept the mesh element and membrane before folding. Gripper pins 314 are extended to hold the membrane and mesh in place during the folding operation. In preferred examples, one gripper pin is placed approximately at each edge of the glue layer. For example, gripper pins may be inserted at approximately the righthand edge and left-hand edge of a membrane, for example, in regions 36 of FIG. 2.

According to this example, material alignment piston 316 is extended down onto the material and the gripper pins are retracted. At least one crimp piston 318 is then extended to crimp the material together to form the glue bond in the fold portion and overlapping with a portion of the mesh, as described, for example in FIG. 1.

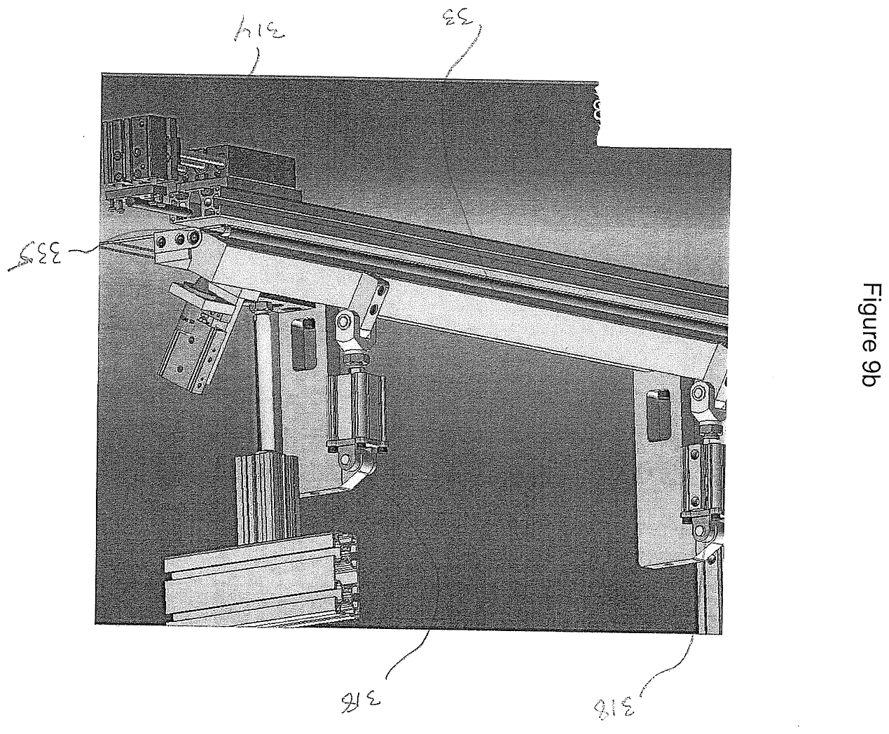

The crimping process is further illustrated in FIGS. 9a and 9b. As shown in FIG. 9a, gripper pin 314 contacts membrane surface 330 to hold the material in place. Only one gripper pin 314 is shown for clarity in FIG. 9a. Crimp pistons 318 are connected to crimping block 331 and are positioned above the membrane and mesh element surface. In FIG. 9b, gripping pin 314 is shown retracted in a horizontal direction, and the membrane is folded over the mesh. Crimp pistons 318 are extended to place crimping block 331 on the first surface of the membrane, forming the fold portion through the pressure of block 331 and the glue layer. In FIG. 9b, the crimping process is shown as not quite complete with a small cavity 335 remaining. The completion of the crimping process results in an assembled leave similar to that shown in FIG. 1. Ultrasonic welders 320 also add a melted weld dot to the outside edge of the material. The material alignment piston and crimp piston are then retracted.

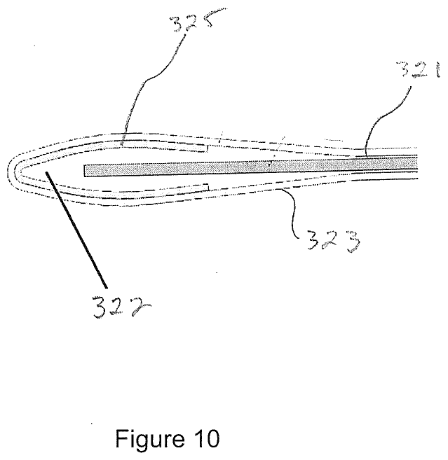

FIG. 10 shows mesh element 321 and folded membrane 323 with glue layer 325 before crimping the membrane to seal it, where a cavity 322 is present. The cavity is maintained by the placement of the gripper pins 314 which are then withdrawn before crimping. As shown in FIG. 2, the glue deposition pattern may be set to create glue excluded zones where the gripper pins are placed during the folding procedure.

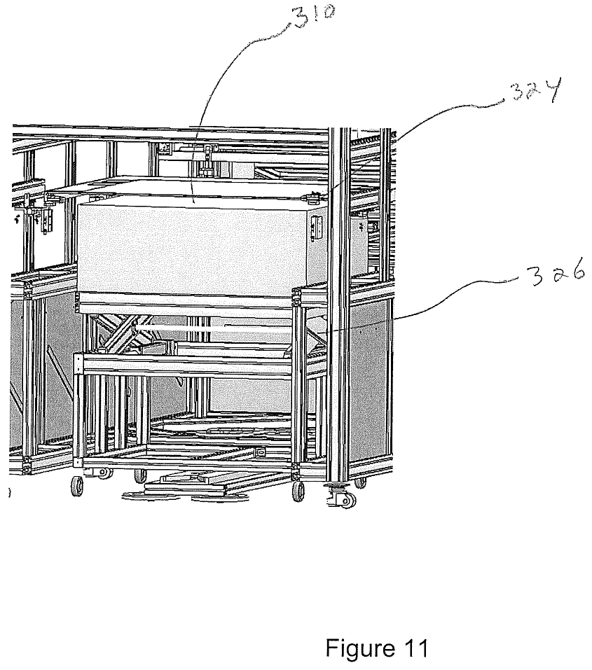

As shown in FIG. 11, finish gripper 324 grab the completed leaves and hold them as the material table brings the leaves to the end of the system. The material bed is then reset forward awaiting the next set of materials. The height adjusting arms 326 allow the completed leaves to stack on top of the previously completed leaves and allow upward and downward movement of the stacked leaves. According to this example, each leaf may be assembled in about 30 seconds to about 60 seconds. In preferred examples, each leave is assembled in about 37 seconds.

In preferred examples, one or more leaves are attached to an element in a reverse osmosis unit at the folded over portion 14. For example, at least one assembled membrane may be attached to a central post in a reverse osmosis unit. A completely flat folded portion 14 ensures a more stable attachment when the assembled membranes are mounted or incorporated into a reverse osmosis element and placed in a water purification system. In preferred examples, four to eighteen leaves are present in a reverse osmosis element. In particularly preferred examples, 17 leaves are assembled into a reverse osmosis element.

The foregoing description is meant to be exemplary only and many modifications and variations of the present disclosure are possible in light of the above teachings. It is, therefore, to be understood that within the scope of the disclosure, systems and methods may be practiced otherwise than as specifically described.

1. An assembled leaf for water filtration, comprising:
a membrane;
said membrane having a first surface and a second surface;
wherein said membrane is configured to form a fold portion;
at least one glue layer applied to said second surface, said at least one glue layer maintaining said fold portion;
at least one mesh element, at least a portion of said at least one mesh element contacting said at least one glue layer; and
wherein said mesh element is not present in said fold portion.

2. The assembled leaf of claim 1, wherein said membrane is a reverse osmosis membrane.

3. The assembled leaf of claim 1, wherein said mesh element comprises polypropylene.

4. The assembled leaf of claim 1, wherein said at least one glue layer is from about 0.2 mil to about 2.0 mil thick.

5. The assembled leaf of claim 1, wherein said at least one glue layer comprises a silicon-based glue.

6. The assembled leaf of claim 1, wherein said at least glue layer comprises glue applied at a temperature from about 325° F. to about 375° F.

7. The assembled membrane of claim 1, wherein said at least one layer of glue is 0.5 mil thick.

8. A method for assembling a leaf for filtration, comprising:
a. providing a membrane, said membrane having a first surface and a second surface;
b. applying at least one glue layer to said second surface of said membrane;
c. inserting at least one mesh element;
d. configuring said membrane and said at least one mesh element to form a fold portion
wherein said at least one glue layer maintains said fold portion and said mesh.

9. The method of assembling a leaf of claim 7, wherein said membrane is a reverse osmosis membrane.

10. The method of claim 7, wherein said at least one glue layer comprises a silicon-based glue.

11. The method of claim 7, wherein said at least one glue layer is applied to said membrane at a temperature of about 350° F.

12. A system for assembling a leaf for filtration, comprising:
a. a glue application station;
said glue application station comprising:
a glue applicator;
b. a leaf fold station;
said leaf fold station comprising:
at least one pair of gripper pins.

13. The system of claim 12, wherein said fold station further comprises at least one crimping piston and at least one crimping block.

14. The system of claim 12, wherein said glue applicator applies at least one glue layer in about one second to about 5 seconds.

15. The system of claim 12, wherein said system assembles a leaf every 30 to 60 seconds.
